(19) United States
(12) Patent Application Publication
(10) Pub. No.: US 2005/0084564 A1
(43) Pub. Date: Apr. 21, 2005

(54) Particulate cheese curd product

(76) Inventors: Craig Graham Honore, Palmerston North (NZ); Andrew John Fletcher, Palmerston North (NZ); Nicola Jan White, Palmerston North (NZ); Richard Archer, Palmerston North (NZ); Paul Mulligan, Hamilton (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/859,745

(22) Filed: Jun. 2, 2004

(30) Foreign Application Priority Data
Jun. 4, 2003 (NZ) 526265
Feb. 12, 2002 (NZ) NZ 517358

(51) Int. Cl. A23C 9/12

(52) U.S. Cl. 426/36

(57) ABSTRACT

A method is described for producing a young cheese or cheese curd in which the natural ripening process is slowed. The method involves fanning a coagulum of cheese curd from milk, salting and draining the whey. The curd is then formed into particles and dried to a preferred moisture level of 5% to 30%. The dried curd particles may be stored over extended periods and then used in the manufacture of processed cheese.

### BACKGROUND OF THE INVENTION

1. Field of the Invention

This invention relates to a cheese curd or young cheese for use in making processed cheese and processed cheese made therefrom. It also relates to a process for manufacturing a curd or young cheese and to the manufacture of processed cheese therefrom.

Processed cheese is made by combining mixtures of young cheese and of matured (flavored) cheese and other ingredients together to obtain the desired combination of compositions texture and flavour. An important attribute of young cheese for this purpose is that it has a high level of intact casein. Intact casein is variously categorised as functional casein, relative casein, structural casein, functional protein and structural protein. All of these meanings and any others understood in the art are intended to be encompassed by this specification.

The terms “curd” and “young cheese” are used interchangeably in this specification. To practise this invention there is no need to determine the precise transition point between them.

2. Description of the Related Art

A cheese may be said to have a life cycle which is divided into three phases. The first of these is the functional phase when the functional properties are predominant. In the second phase the cheese has lost most of its functional properties but not yet developed its flavor. It is used as a filler in the second phase. In the third phase the cheese has ripened to release its flavours. It is a combination of bacterial and enzymatic action causing the maturation or ripening of cheese during the three phases which results in a progressive breakdown of intact casein. It is of benefit to be able to extend the functional or first phase of the cheese aging cycle. It allows the manufacture of cheeses using the functional properties over a greater period of time. Where a market is remote from where the young cheese is made, delays in transport do not cause a loss in value. It also allows cheese to be manufactured over twelve months of the year, rather than being tied to the milking season.

One way of slowing or arresting cheese maturation and the breakdown of intact casein is to chill or freeze young cheese. In U.S. Pat. Nos. 5,773,054 and 5,783,236 there is described a process for producing a young cheese in a particulate form. Fresh cheese curd is drained, salted and milled and cooked in a particulate form. The product is then cooled and optionally dried to a minimum moisture content of 33 to 36% (W/W). The effect of the drying and cooling processes is to yield fresh curd particles which do not knit when they are packaged in bulk and stored. The product may optionally be allowed to mature and is not stable to bacterial or enzymatic maturation processes.

Where young cheese is supplied in bulk (for example 200 kg blocks) it cannot be cooled quickly enough to slow or halt the initial proteolysis reaction.

It would be desirable to be able to produce a cheese curd or a young cheese without the expense of the chilling or freezing. Such a stabilized cheese curd would then be able to be made into processed cheese at a site and time chosen by the processed cheese manufacturer.

It is an object of this invention to go some way towards achieving these desideratum or at least to offer the public a useful choice.

### SUMMARY OF THE INVENTION

Accordingly, the invention may be said broadly to consist in a method for producing a particulate cheese curd suitable for the preparation of a processed cheese comprising the steps of:
forming a coagulum of cheese curd from milk, salting said coagulum and draining whey therefrom to form a curd,
forming said curd into particles with a particle size suitable for drying, and
drying said forming curd particles to a moisture level between 5% and 30% (W/W).

Preferably, said coagulum is formed by adding any source of clotting enzyme or any clotting enzyme to milk.

Preferably said source of clotting enzyme is rennet.

Alternatively, said coagulum is formed by adding food grade acid to milk.

In a third alternative said coagulum is formed by adding both a source of clotting enzyme and a food grade acid.

In one alternative said curd is formed into particles by stirring said coagulum.

In another alternative said curd is formed into particles by milling.

In one alternative said milk is whole milk.

In another alternative said milk is skim milk.

In a third alternative said is a cheese milk.

Preferably, said curd is milled to a particle size no greater than 20 mm mesh.

More preferably, said curd is milled to a particle size no greater than 10 mm mesh.

More preferably, said curd is milled to a particle size no greater than 7.5 mm mesh.

More preferably, said curd is milled to a particle size no greater than 4 mm mesh.

Most preferably, said curd is milled to a particle size no greater than 3 mm mesh.

Preferably, said curd particles are dried to a moisture level of from 5 to 25% (W/W).

More preferably, said curd particles are dried to a moisture level of 22 to 23% (W/W).

In one alternative said drying step is a batch process.

In another alternative said drying step is a continuous process.

Preferably, said continuous process comprises one or more stages carried out in parallel or in sequence.

Preferably, said curd particles are dried with a fluid bed dryer.

More preferably, said dryer is a multi-stage fluid bed dryer.

In one embodiment, where said dryer is a multi-stage fluid bed dryer, partially dried curd is milled after emerging from one stage and before entering a next stage.

Preferably, said curd particles are dried with an air dryer with its air temperature in the range of 20° C. to 80° C.

More preferably said temperature is in the range of 20 to 50° C.

Preferably said particulate curd is dried under conditions where it is not heated to above the melting point of any fat contained therein.

In one embodiment after said cord particles are formed, they are salted.

In another embodiment the invention may be said broadly to consist in a particulate cheese curd produced by the process described herein above.

In another embodiment the invention may be said broadly to consist in a particulate cheese curd having a particle size no greater than 20 mm mesh and having a moisture content between 5% and 30% (W/W).

Preferably, said particle size is no greater than 10 mm mesh.

More preferably, said particle size is no greater than 7.5 mm mesh.

More preferably, said particle size is no greater than 4 mm mesh.

Most preferably, said particle size is no greater than 3 mm mesh.

Preferably, the moisture content of said particles is between 5 and 25% (W/W).

Most preferably, the moisture content of said particles is from 22 to 23% (W/W).

The invention may also be said broadly to consist in the use of a particulate cheese curd as defined above in the manufacture of processed cheese.

The invention may also be said to consist in a processed cheese produced using a particulate cheese curd as defined herein.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

The invention may be more fully understood by having reference to the accompanying drawings wherein:

FIG. 1A represents the control in Example 3. It is a plot of the log-linear levels of decay of αₛ₁—casein (●) and β—casein (▴) against time in a particulate curd control sample with a moisture content of 32.5% (W/W).

FIG. 1B represents trial 1 in Example 3. It is a plot of the log-linear levels of decay of αₛ₁—casein (●) and β—casein (▴) against time in a particulate curd sample dried to a moisture content of 22-23% (W/W).

FIG. 1C represents trial 2 in Example 3. It is a plot of the log-linear levels of decay of αₛ₁—casein (●) and β—casein (▴) against time in a particulate curd sample dried to a moisture content of 28-30% (W/W).

FIG. 1D represents trial 3 in Example 3. It is a plot of the log-linear levels of decay of αₛ₁—casein (●) and β—casein (▴) against time in a particulate curd sample dried to a moisture content of 22-23% (W/W).

FIG. 1E represents trial 4 in Example 3. It is a plot of the log-linear levels of decay of αₛ₁—casein (●) and β—casein (▴) against time in a particulate curd sample dried to a moisture content of 28-30% (W/W).

FIG. 2 represents a plot of measured breakdown rates of αₛ₁—casein (●) and β—casein (▴) in the cheese curd versus cheese curd moisture level.

### DETAILED DESCRIPTION OF THE PREFERRED EMBODIMENTS

We have discovered that drying reduces the rate of breakdown of selected casein proteins in a particulate cheese curd or young cheese. It is believed that the state of the selected proteins reflects the level of intact casein in cheese.

Cheese curd, or cheese-like curd including skim milk cheese curd, may be produced by any means known in the art. Typical methods for producing cheese curd are described in Kosikowsky et al (1997).

In one embodiment, upon the completion of salting and the draining of any excess whey, fresh cheese curd is milled and fed into a dryer. The dryer may be batch or continuous and may consist of one or more stages used in parallel or in sequence.

In an alternative embodiment the whey and curds are stirred continually during cooking. After removal of whey, the curd continues to be stirred during subsequent stages of curd handling including salting. When such a step is employed milling may not be required to put the curd into a particulate form for drying.

A preferred design of dryer is a fluid bed dryer and a more preferred dryer is a multi-stage fluid bed dryer. Optionally between dryer stages further curd milling, size reduction or screening devices may be deployed.

The dryer is supplied with a drying medium. A preferred drying medium is air and more preferably the air is heated. Optionally the drying medium may be dehydrated or dehumidified prior to entry to the fluid bed or contact with the material to be dried. Optionally the drying medium may be recycled.

At the exit of the dryer, the curd particles have a preferred moisture content between 5% and about 30% by weight.

In a preferred embodiment, the air to the dryer should be less than 80° C. and greater than 20° C. Optionally the characteristics of the drying medium (temperature and humidity) supplied to the various stages may be varied between the stages.

Further, we have discovered that we can obtain very desirable intact casein preservation levels at moisture concentrations that serendipitously halt the growth of spoilage organisms at ambient temperature. Thus in a preferred embodiment it is convenient to store the dried product at ambient temperature.

Optionally, the dried product may be stored at below ambient temperature and preferably below 0° C.

### EXAMPLE 1

### Preparation of Curd for Drying

Cheddar-style cheese curd was prepared as follows.

A cheese vat was filled with 375 L of pasteurized milk that had been standardized to a protein to fat ratio of 0.78. The temperature of the cheese milk was adjusted to 32° C. Mesophilic starter at the rate of 2.4% of cheese milk, coagulant at the rate of 6 ml/100 L of cheese milk and CaCl₂ at the rate of 0.02% were added and thoroughly mixed with the cheese milk.

After about 20 minutes setting, the gel was cut using a 6 mm curd knife. While being stirred, the curds and whey were then heated to 38.5° C. over a period of 40 minutes and allowed to cook.

The whey was drained from the curds after a further 2¾ hours. The curd was stirred six times in the first 18 minutes, then three times in the following 15 minutes and once every 10 minutes. Once the pH had reached approximately 5.2, salt was added to the curd at the rate of 22 g/kg. The curd was mellowed a further 20 minutes.

### EXAMPLE 2

### Drying of Curd

Four 9 kg batches of milled curd prepared in a manner similar to that in example 1 were dried using a low humidity, low temperature dryer. The samples of curd were dried over two days at 10° C. Approximately 9 kg of curd was weighed out onto 12 drying stainless steel drying trays, and this procedure was repeated with 4 separate drying trials over 2 days. The air temperature, relative humidity and average cheese moisture levels for each dryer trial is own in Table 1.

TABLE 1
Curd drying conditions.

| | | | | Final Average |
|---|---|---|---|---|
| | Air Temp | Relative | | Curd |
| | Range | Humidity Range | | Moisture (% |
| Trial No. | (Inlet) | (Outlet) | Drying Time | W/W) |
| 1 | 34-35° C. | 60-80% | 4 hrs | 22.5 |
| 2 | 34-35° C. | 60-80% | 1.5 hrs | 28.2 |
| 3 | 34-36° C. | 40-50% | 2 hrs | 21.8 |
| 4 | 34-36° C. | 40-50% | 1.25 hrs | 29.5 |

The average composition of the dried curd samples is shown in Table 2.

TABLE 2
Composition of dried curd samples.

| | Mois- | Fat | | Salt | Protein | | | |
|---|---|---|---|---|---|---|---|---|
| | ture (% | (% | | (% | (% | S/M | FDM | MNFS |
| | w/w) | w/w) | pH | w/w) | w/w) | (%) | (%) | (%) |
| Control | 32.5 | 36.5 | 5.55 | 1.85 | 24.6 | 5.7 | 54 | 51.2 |
| Trial 1 | 22.5 | 41.4 | | 2.53 | 29.3 | 11.2 | 53 | 38.4 |
| Trial 2 | 28.2 | 38.0 | | 2.22 | 26.8 | 7.9 | 53 | 45.5 |
| Trial 3 | 21.8 | 41.1 | | 2.70 | 29.5 | 12.4 | 53 | 37.0 |
| Trial 4 | 29.5 | 37.0 | | 2.16 | — | 7.3 | 52 | 46.8 |

¹S/M (Salt in moisture)
FDM (Fat in dry matter)
MNFS (Moisture in non-fatty substance)

### EXAMPLE 3

### Storage and Proteolysis Measurements

Dried cheese samples were stored for an extended period (3 months) at 10° C., and sub-sampled at regular intervals. The extent of casein proteolysis was determined using well-established electrophoretic methods (Alkaline Urea PAGE). See Creamer (1991).

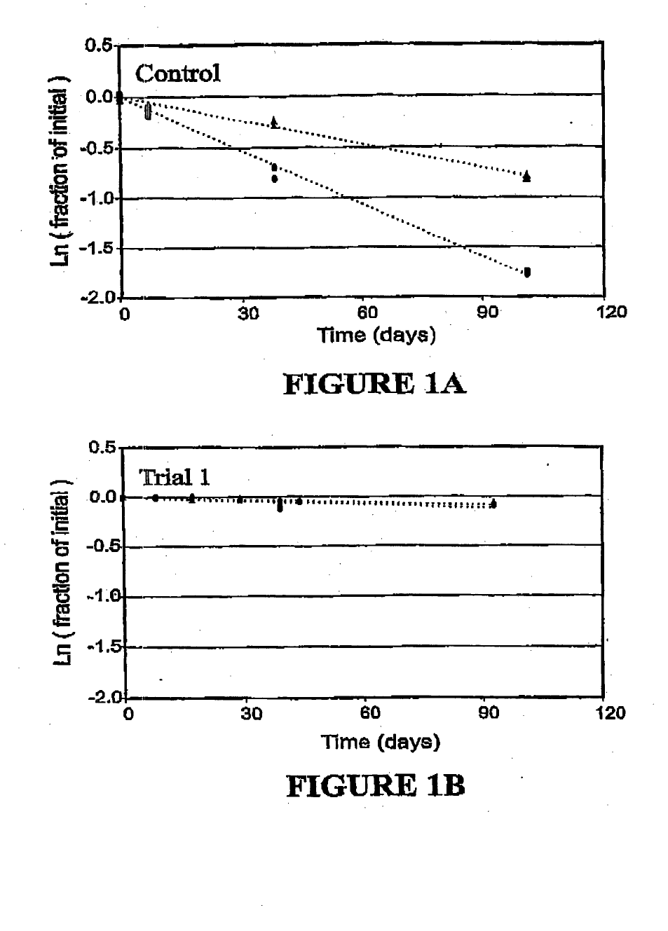

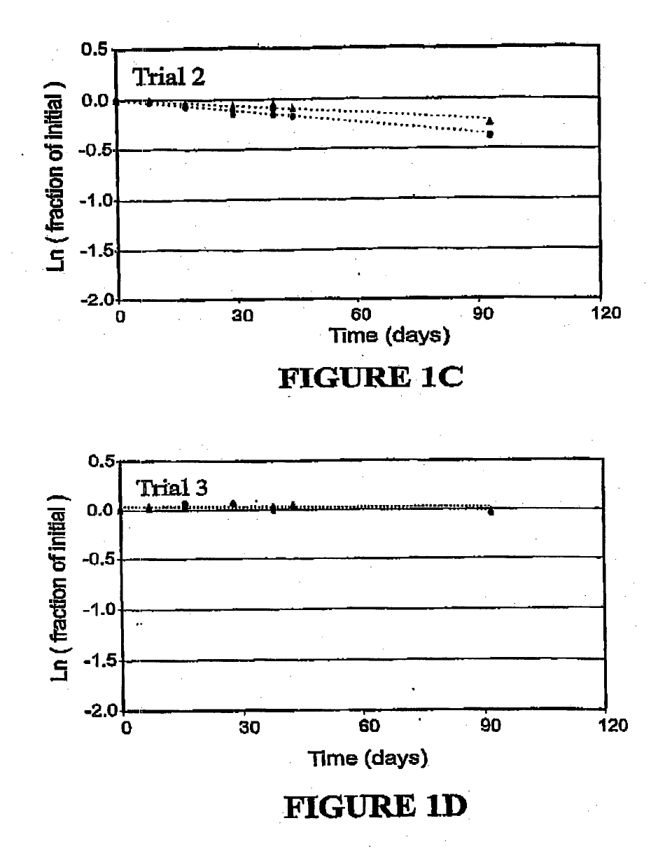

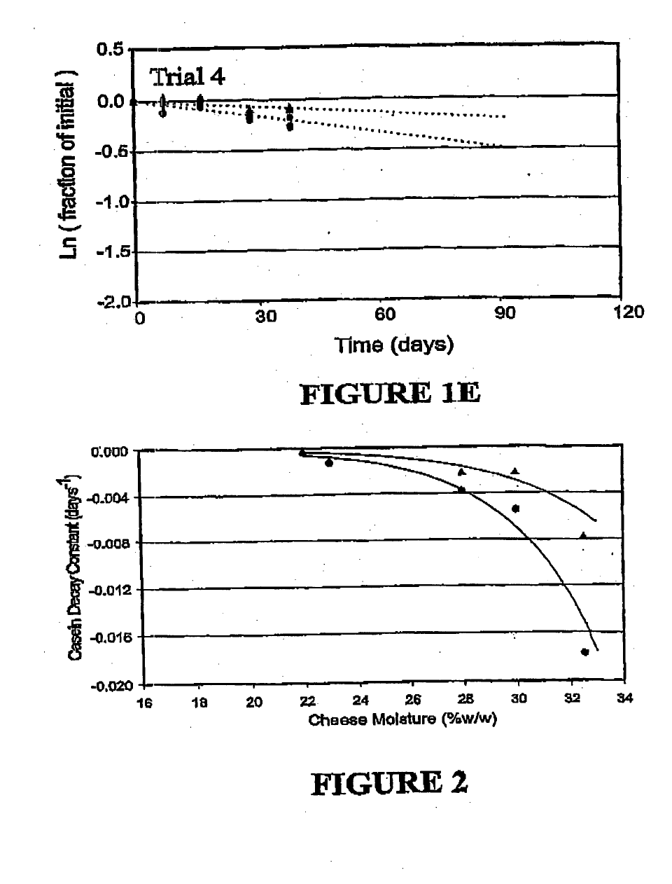

The results of the measured casein breakdown from the PAGE analyses were measured and are set out in FIGS. 1a to 1e. The rates of α_{S1} and β-casein decay were plotted and correlated using log-linear plots and showed that drying had a very significant effect on the rate of casein breakdown.
Samples dried to 22-23% moisture (Trials 1 and 3, FIGS. 1B and 1D) had minimal levels of casein decay, >90% of both α_{S1} and β-casin remained after 3 months at 10° C., compared to non-dried control sample (FIG. 1A—32.5% moisture) where <20% of α_{S1} and approx. 40% β-casein remained after 3 months storage at 10° C.
Samples dried to an intermediate moisture level (28-30% moisture) (Trial 2 moisture) (Trial 2 and 4, and FIGS. 1C and 1E) had lower levels of casein decay (>35% of α_{S1} and >90% of β-casein remained) after 3 months at 10° C., compared to non-dried control (FIG. 1A).

The relationship between moisture level of dried cheese curd and the observed rate constants for both α_{S1}- and β-casein were non-linear in nature, but followed similar traits (refer to FIG. 2).

The experiments revealed that at moisture levels of <25% w/w the rate of breakdown of casein in cheese curd was so dramatically reduced that there was a likelihood of maintaining satisfactory intact casein levels for a period of some months at ambient temperature or near ambient temperature.

### EXAMPLE 4

### Drying of Curd

2 kg of salted and drained cheese curd (moisture 38.4%, fat 31%, protein 25.3%, salt 3.13%) prepared as described in example 1 was in a particulate form as a result of the stirring after the whey had been removed. A sieve analysis shown in Table 3.

TABLE 3
Sieve analysis of curd particle size (% retained)

| | Screen mesh size | | | | |
|---|---|---|---|---|---|
| | 1 mm | 3 mm | 4 mm | 7.5 mm | ∞ |
| Curd A | 1 | 72 | 17 | 10 | 0 |

The particulate curd was dried using a Uniglatt batch fluid bed dryer (Glatt Process Technology GmbH, Binzen, Germany) equipped with a Munters dehumidifier (Munters ML 180E dehumidifier, Munters Europe, Tobo, Sweden) fitted to the dryer air supply.

The dehumidified air had a relative humidity of 6% at 27° C. (absolute humidity 1.3 g/kg dry air). The inlet air was electrically heated to 28° C. prior to entering the fluid bed. An airflow of 3 kg/min was used.

The moisture content of the curd in the dryer was determined by withdrawing small samples (approximately 16 g) at regular intervals for analysis (16-hour oven drying method). The fluid bed temperature and the moisture content over the course of the drying are shown in Table 4.

TABLE 4
Experimental drying results for sample 1

| | | Curd Moisture |
|---|---|---|
| | Fluid Bed Air | Content |
| Time (minutes) | Temperature (° C.) | (% W/W) |
| 5 | 18.2 | |
| 10 | 19.2 | 31.01 |
| 15 | 19.2 | |
| 20 | 19.3 | 26.42 |
| 25 | 19.4 | |
| 30 | 19.9 | 20.85 |
| 40 | 22.5 | 18.91 |
| 45 | 23.8 | |
| 50 | 24.7 | 17.78 |
| 55 | 25.4 | |
| 60 | 25.7 | 16.42 |

### EXAMPLE 5

### Preparation of a Processed Cheese from Dried Curd

The ingredients in table 5 were reduced to a uniform particle size by passing through a 5 mm cheese grinder and then placed in a 25 kg capacity Blentech (model no. CC45) cooker.

TABLE 5
Initial Ingredients

| Ingredients | Kg |
|---|---|
| Dried cheese curd (22% moisture) | 3.500 |
| Young cheese | 0.400 |
| Medium cheese | 2.975 |
| Mature cheese | 1.200 |
| Butter | 0.800 |

The ingredients in table 6 were also added to the cheese in the Blentech cooker.

TABLE 6
Additional Ingredients

| Ingredients | Kg |
|---|---|
| Melting salts | 0.390 |
| Salt | 0.055 |
| Rework cheese | 0.25 |
| Sorbic acid | 0.011 |
| Water | 1.200 |

The mixture was blended using an auger speed of 120 rpm. 0.026 kg of citric acid was added and the mixture was to 87° C. over a period of about 1 minute using direct steam injection. This temperature was maintained for about 6 minutes. During the heating, approximately 1.47 kg of condensate was added and incorporated into the mixture.

The molten mixture was poured through a colloid mill before being cast on a chilled table, whereupon the film of cheese was cut into slices. The chilled slices were a processed cheese slice of acceptable quality for IWS application.

It is not the intention to limit the scope of the invention to the above abovementioned examples only. As would be appreciated by a skilled person in the art, many variations are possible without departing from the scope of the invention.

### REFERENCES

Creamer, L. K. (1991) Electrophoresis of cheese. Bull Int Dairy Fed 261, 14-28.
Kosikowski F. V. & Mistry V. V. Cheese and Fermented Milk Foods. Volume 1: Origins and Principles 3^{rd} ed. 1997. Chapts. 7 & 13. Kosikowaki, Great Falls, Va. 22066, USA.

1. A method for producing a particulate cheese curd suitable for the preparation of a processed cheese comprising the steps of:
forming a coagulum of cheese curd from milk, salting said coagulum and draining whey therefrom to form a curd;
forming into curd into particles with a particle size suitable for drying; and
drying said formed curd particles to a moisture level between 5% and 30% (W/W).

2. The method of claim 1, wherein said coagulum is formed by adding any source of clotting enzyme or any clotting enzyme to milk.

3. The method of claim 2, w herein said source of clotting enzyme is rennet.

4. The method of claim 1, wherein said coagulum is formed by adding food grade acid to milk.

5. The method of claim 1, wherein said coagulum is formed by adding both a source of clotting enzyme and a good grade acid.

6. The method of claim 1, wherein said curd is formed into particles by stirring said coagulum.

7. The method of claim 1, wherein said curd is formed into particles by milling.

8. The method of claim 1, wherein said milk is whole milk.

9. The method of claim 1, wherein said milk is skim milk.

10. The method of claim 1, wherein said milk is a cheese milk.

11. The method of claim 7, wherein said curd is milled to a particle size no greater than 20 mm mesh.

12. The method of claim 7, wherein said curd is milled to a particle size no greater than 10 mm mesh.

13. The method of claim 7, wherein said curd is milled to a particle size no greater than 7.5 mesh.

14. The method of claim 7, wherein said curd is milled to a particle size no greater than 4 mm mesh.

15. The method of claim 7, wherein said curd is milled to a particle size no greater than 3 mm mesh.

16. The method of claim 7, wherein said curd particles are dried to a moisture level of from 5 to 25% (W/W).

17. The method of claim 16, wherein said curd particles are dried to a moisture level of 22 to 23% (W/W).

18. The method of claim 1, wherein said drying step is a continuous process.

19. The method of claim 18, wherein said continuous process comprises one or more stages carried out in parallel or in sequence.

20. The method of claim 1, wherein said drying step is a batch process.

21. The method of claim 1, wherein said particles are dried with a fluid bed dryer.

22. The method of claim 21, wherein said dryer is a multi-stage fluid bed dryer.

23. The method of claim 22, wherein partially dried curd is milled after merging from one stage and before entering a next stage.

24. The method of claim 1, wherein said curd particles are dried with an air dryer with its air temperature in the range of 20° C. to 80° C.

25. The method of claim 24, wherein said temperature is in the range of 20° C. to 50° C.

26. The method of claim 1, wherein said particulate curd is dried under conditions where it is not heated to above the melting point of any fat contained therein.

27. The method of claim 1, wherein after said curd particles are formed, they are salted.

28. A particulate cheese curd produced by the process of claim 1.

29. A particulate cheese curd having a particle size no greater than 20 mm mesh and having a moisture content between 5% and 30% (W/W).

30. A cheese curd as claimed in claim 29, wherein said particle size is no greater than 10 mm mesh.

31. A cheese curd as claimed in claim 29, wherein said particle size is no greater than 7.5 mm.

32. A cheese curd as claimed in claim 29, wherein said particle size is no greater than 4 mm mesh.

33. A cheese curd as claimed in claim 29, wherein said particle size is no greater than 3 mm mesh.

34. A cheese curd as claimed in claim 29, wherein the moisture content of said particles is between 5 and 25% (W/W).

35. A cheese curd is claimed in claim 29, wherein the moisture content of said particles is from 22 to 23% (W/W).

36. A method of producing processed cheese, comprising: producing a particulate cheese curd as claimed in claim 28; and combining the cheese curd and a matured cheese to form a processed cheese.

37. A method of producing processed cheese, comprising: producing a particulate cheese curd as claimed in claim 29; and combining the cheese curd and a matured cheese to form a processed cheese.

38. A processed cheese comprising the particulate cheese curd as claimed in claim 29.
